(19) United States
(12) Patent Application Publication
(10) Pub. No.: US 2016/0026359 A1
(43) Pub. Date: Jan. 28, 2016

(54) CLOUD BASED OPERATING SYSTEM AND BROWSER WITH CUBE INTERFACE

(71) Applicant: Christian Alfred Landsberger Glik, Miami, FL (US)

(72) Inventor: Christian Alfred Landsberger Glik, Miami, FL (US)

(21) Appl. No.: 14/716,492

(22) Filed: May 19, 2015

Related U.S. Application Data
(60) Provisional application No. 62/000,620, filed on May 20, 2014.

(51) Int. Cl. G06F 3/0481; G06T 13/20; G06F 17/22; G06T 15/10

(52) U.S. Cl. CPC G06F 3/04815; G06F 3/04817; G06T 15/10; G06T 13/20; G06F 17/2247; G06F 17/2235; G06F 17/2288; G06T 2200/24

(57) ABSTRACT

A user interface and or browser is provided having a tilted cube hexagonal structure. The cube is rotatable and has advertisements and theme based window panes on the back and the front of the panes. The cube is rotated in such a fashion that the tilted orientation is maintained constant but the panes revolved about a tilted axis much as the Earth revolves about its axis. Computer software coordinates the responses of keyboard, mouse and other devices as they interact with the cube itself so as to provide a stimulating 3D graphical user interface. The system is applicable to mobile devices such as smart phones and similar devices.

### FIELD OF THE INVENTION

This invention relates to improvements in browser and operating system technologies. More particularly, this invention relates to 3D Interface with which a user can more readily access his local computer, browse on the web or control cloud based resources.

### BACKGROUND OF THE INVENTION

3D Computer Graphics: Modern computing reached the point some time ago that realistic representations of objects can be represented in a two dimensional video screen in real time. The process of creating a 3D graphic falls generally into three phases comprising: Modeling, Animation and Rendering. The modeling phase is the process of forming an object's shape in an electronic computer model. Scanned images or those created by an engineer from a 3D modeling tool are entered into a computer for the computational creation of polygonal wireframes having vertices. Following this a designer would continue by animating and preparing the layout within a background. In this process the interactions between objects is defined including its magnitude, position and how the objects move or change shape.

The process is finished once it is rendered by computer; at this point it has created the image based on it calculating several factors such as lighting, surface textures and other variables. To get imagery that is of such good quality that it convinces the most discerning viewer, the characteristics of how light plays with the object are calculated in the best type of 3D rendering. Thus, the quantity and quality of light interaction with the subject being rendered is computed using graphics software. Finally, to make the scene to illustrate and present a 3D image in two dimensions requires a projection technique that is utilized to present a proper image.

Mobile Phone Operating System: A mobile operating system, also referred to as mobile OS, is an operating system that operates a smartphone, tablet, PDA, or other mobile device. Modern mobile operating systems combine the features of a personal computer operating system with other features, including a touchscreen, cellular, Bluetooth, GPS mobile navigation, camera, video camera, speech recognition, voice recorder, music player, near field communication and infrared blaster. Mobile devices with mobile communications capabilities (e.g. smartphones) contain two mobile operating systems—the main user-facing software platform is supplemented by a second low-level proprietary real-time operating system which operates the radio and other hardware. Typical examples of mobile operating systems include Android, Blackberry, iOS, Windows, Firefox, Sailfish, Symbian, Tizen, Ubuntu Touch and more.

Current Computer Tech: A very common type of computer architecture is known as the client-server model. This structure distributes access to resources found on computers known as servers and those attempting to access those resources that are known as clients. Thus, clients request the use of applications, data, hardware or software resources controlled by servers. Clients can be located on the same system with a server or they may have to talk to each other via an intervening medium such as a computer network. The internet is the most common server architecture available today; as millions of servers control access to a seemingly limitless amount of information on the web.

These servers execute server side control programs that are capable of controlling accessibility of server based hardware, software, data, applications and more. Typically a user starts his browser on his local computer or other internet capable device to begin to surf the web. These browsers are essentially a software application that accesses a resource and displays it to a surfer as he or she is searching through information resources on the web. Typically a user resource is located utilizing something known as a URL or uniform resource locator that ultimately points to an image, video, page or other data; the browser interacts with the internet using the user's internet service connecting with the rest of the web via an Internet Protocol suite more widely known as the TCP/IP protocol.

This Transmission Control Protocol and the Internet Protocol were the first networking protocols utilized in the internet backbone. The Routing, Addressing, Transmission, Reception and Formatting of data is handled by this standard TCP/IP protocol. There are four layers of abstraction that control the linking, internet, transport and application layers that correspond to various services beyond the scope of this discussion. Suffice it to say that as a user selects a hyperlink the resource so selected is presented to the user; thus, it is easy to gain access to data, video, images, application and other resources. Thus, a networked computer uses a hyperlink to rapidly secure online resources; hyperlinks are highlighted, underlined or otherwise marked so as to alert a user as to the special nature of the item being shown on the computer screen.

The internet has now evolved from a standalone computer having its own local applications and resources to the concept of the Cloud or Cloud Computing. There are various interpretations of this term that are discussed in the following. Its most prevalent conceptualization is that of providing services or software applications that are run on a remote location. Another meaning of the term is similar to distributed computing in that it means the capability to simultaneous execute an application or sequence of steps on a plurality of requesting computers. Cloud computing can also include the virtualization of hardware which provide services to an end user of aforementioned as if there was actual hardware in existence. The virtual hardware is simulated to the end user utilizing software that provides the illusion of this hardware on actual hardware. As these are virtual devices, the service can be upgraded or downgraded without interfering with an end user's experience since he exists in a virtual environment. This because the user service exists out in a virtual cloud.

As these virtualization concepts continue to spread throughout the globe software developers have taken up the gauntlet of providing cloud based browsing. One such group is Chinese based Maxthon; this company created several browsing applications but is known for the Maxthon Cloud released in December 2012. The simultaneous release of its Passport permitted users to signup for cloud based services and other features such as: Cloud Push, Cloud Share, Cloud Download, My Cloud Tabs, Cloud Sync, Reader Mode, Magic Fill, Ad Hunter, New Session, Source Sniffer, private web browsing and more all using cloud computing technology.

However, all of the aforementioned fails to teach how to make the user experience easier in its direct graphical user interface. In fact, whilst the cloud based system has economized application usage through the use of virtual hardware, and has indeed seamlessly provided resources to a user, it is nevertheless the same search entry screen and hyperlink browser page to which one is directed. Thus, cloud computing has improved the background overhead and passed some of the savings on to the user but his or her direct interaction at his computer station or terminal remains paralyzed in the past. It is the same graphical user interface that uses only two dimensions to express information, video, images and other content in a familiar browser page design.

Accordingly, there needs to be some solution to overcome the aforementioned problems.

### SUMMARY OF THE INVENTION

The present invention overcomes the deficiencies of the known art and the problems that remain unsolved by providing a Cloud Based Operating System And Browser With Cube Interface as described below:
A three dimensional browser interface comprising:

a rotatable object having

a pane with
a category theme.
In another aspect, further comprising:

a link within the pane.
In another aspect, further comprising:

an icon within the pane.
In another aspect, further comprising:

an interactive link associated with the icon.
In another aspect, further comprising: wherein the rotatable object is a polygon.
In another aspect, further comprising:

a plurality of panes connected together wherein each pane is connected to only 2 adjacent panes along edges thereof in a regular polygon structure.
In another embodiment, a method of creating a graphical user interface GUI comprising the steps of:

creating a 3D model of the GUI

generating a 3D animation layout of the GUI

creating a 3D rendering of the GUI and

combining the rendering of the GUI with a user interface routine.
In another aspect, further comprising: wherein the user interface routine is a mouse interaction routine.
In another aspect, further comprising: wherein the user interface routine is a keyboard interaction routine.
In another aspect, further comprising: wherein the user interface routine is a category interaction routine.
In another aspect, further comprising: wherein the GUI is a 3D regular polygon loaded onto a video screen.
In another embodiment, a computer program product comprising:

creating a basic set of panes

downloading a category update

checking a user customization flag.
In another aspect, further comprising:

loading an update if the user customization flag is not set.
In another aspect, further comprising:

linking the update with an executable file.
In another aspect, further comprising:

loading the update into video RAM.
In another aspect, further comprising:

determining if a user wants to load an update if a user customization flag is set.
In another aspect, further comprising:

checking to see if there is an update available if the user does not want to load the update.
In another aspect, further comprising:

loading an update if the user permits updating even though a user customization flag is set.
In another aspect, further comprising:

linking the update with an executable file.
In another aspect, further comprising:

loading the update into video RAM.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 represents a front elevation view of a hexagonal cube of an embodiment showing groups of logical organized subject matter along with ads within the various groups.

FIG. 2 shows the basic process for generating a hexagonal cube of an embodiment having logically organized subject matter along with ads within the various groups.

FIG. 3 illustrates the basic process for a user to update his personal space by adding or removing particular items from a category or creating a completely new category according to user requirements.

FIG. 4 illustrates how an external file is downloaded via internet so as to update the category headings, basic links, icons and other matter on a continuing basis.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The following embodiments teach a browser or desktop graphical user interface that provide an easy to use 3D type of rotational interface tilted at an angle. The interface itself is created using software and can be programmed in any language, C, C++, fortran, JAVA etcetera. This GUI is then interlaced with browser or other operating system software in order to perform the specific functions of each. Links are presented on the surface of the panes of the cube based upon the basic programming of the cube; they start from a default set of panes, category heading and basic links therein. They can be configured dynamically by the user interacting with them to remove, rename, add, change color etc or automatically changed from a downloaded update.

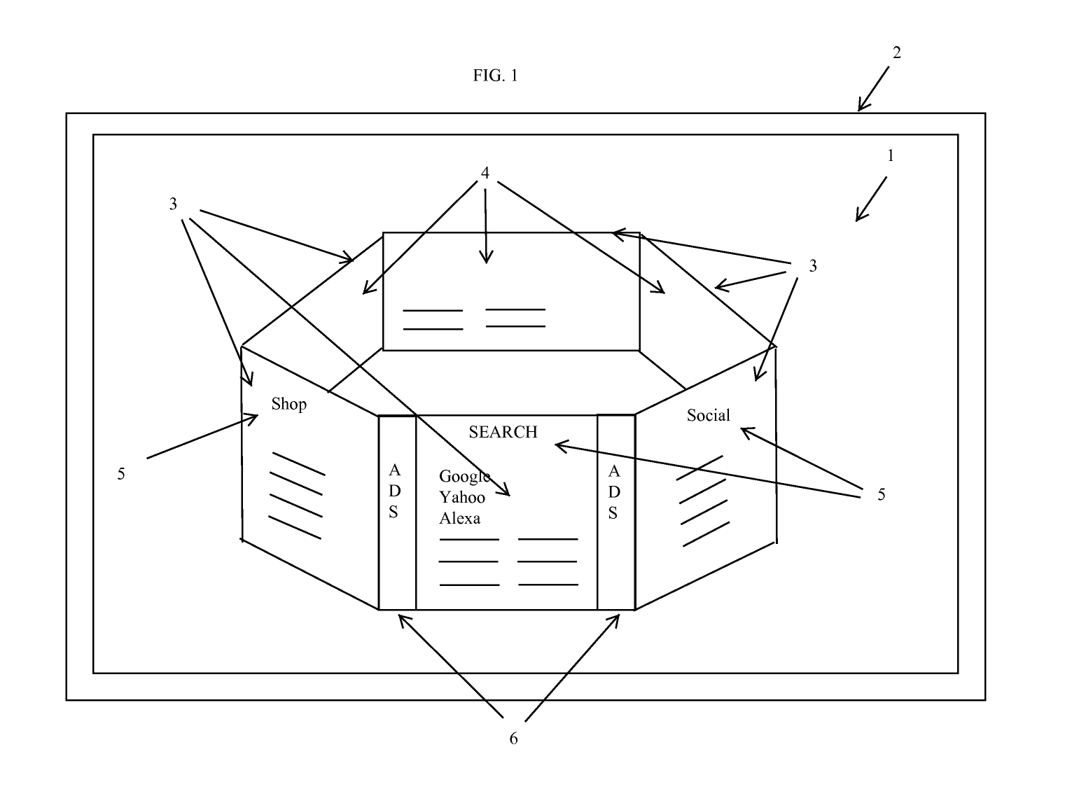

FIG. 1 represents a front elevation view of a hexagonal cube of an embodiment showing groups of logical organized subject matter along with ads within the various groups. A hexagonal hollow cube, or cube 1 for short, is shown on a computer video screen 2. The cube 1 is made up from six sides or panes 3; the total front visible surface area of the cube 1 is the total area of three sides in FIG. 1 for viewing imagery (such as hyperlinks, video, pictures, text). The cube 1 is oriented in a somewhat tilted fashion so that the front of the cube 1 is lower than the back of the cube 1. This permits the viewing of imagery (such as hyperlinks, video, pictures, text) on the back surfaces 4 of the panes 3. At the top of each pane 3 is shown a category name that starts at a default values and are changeable according to user wishes. Also, advertisements are represented along a rectangular space at each end of a pane 3 adjacent the edge between panes 3. The back sides 4 of panes 3 may also optionally have advertising or other information presented within its area.

The basic process of loading these is to load the dimensions and graphical information for the cube into video, then the default categories follow, and to populate the default hyperlink set for one category pane after another until the panes (including the back ones) are complete. A user can alter a pane's appearance by selecting a menu of actions to change its appearance, shape, theme, color, text.

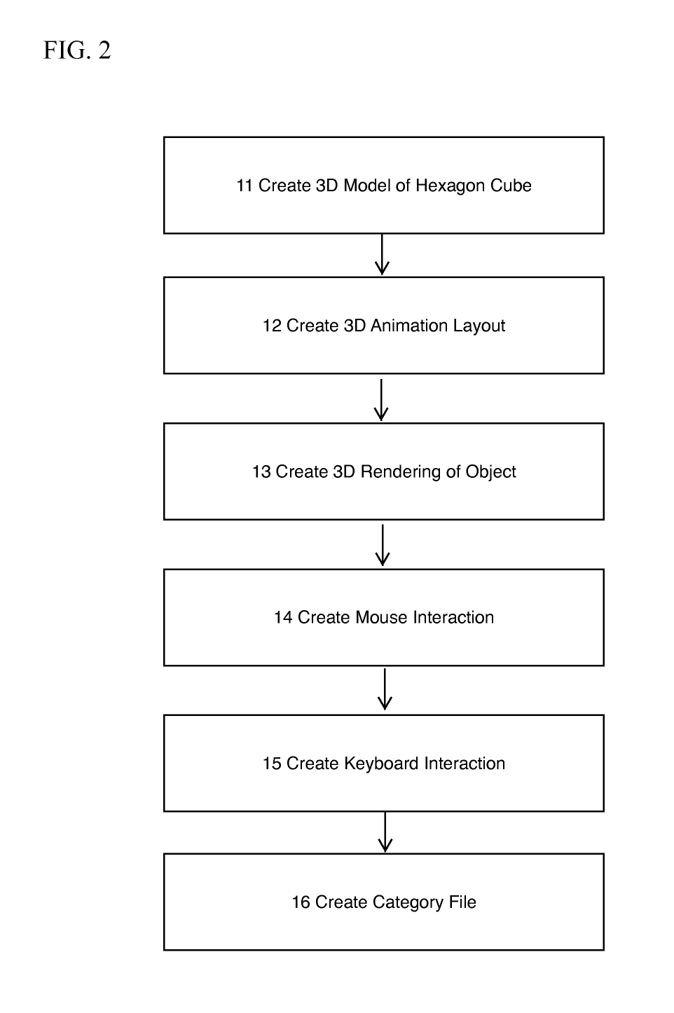

FIG. 2 shows the basic process for generating a hexagonal cube of an embodiment having logically organized subject matter along with ads within the various groups. In the first block a 3D model of the cube 1 is created 11 representing the object. Next a 3D animation is generated 12 so as to define how the cube 1 moves on the screen and how it rotates in real time. Finally, a 3D rendering of the object is completed 13 that has proper lighting and projection into a two dimensional video image. Each of these steps has a unique requirement in that space on the cube 1 and each of its panes 3 is dynamically configurable by the user and updatable by background software from a central server computing usage characteristics.

To properly display the links on the panes 3 several sub-files are necessary that are continuously monitored for changes. These files are either embedded within the animation programming of cube 1 or called as subroutines from within them. As a user interacts with a mouse, keyboard or an update is sent from an external approved source such as an authenticated cloud server. Each of these subroutines or files governs the cube's 1 reactions according to a prearranged set of rules that covers the rotation of the cube 1, placement of imagery on each pane 3, and addition or removal therefrom based upon user interaction. Thus, a mouse interaction file or sub-routine 14 is created; then a keyboard interaction sub-routine 15 is created and finally a category sub-routine or file is generated 16. Additional files or sub-routines interlacing the audio, printers and other peripherals with the cube 1 activity are optionally included.

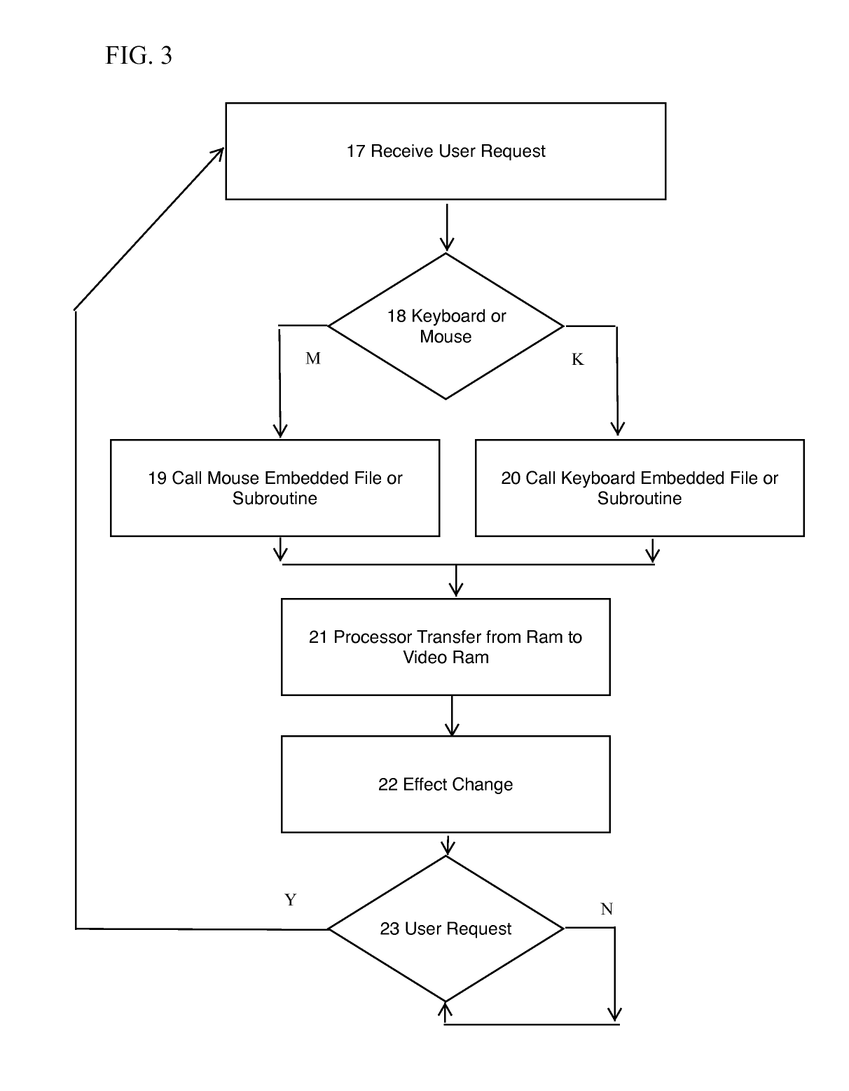

FIG. 3 illustrates the basic process for a user to update his personal space by adding or removing particular items from a category or creating a completely new category according to user requirements. This process is also used for user rotation of the cube on screen using mouse or keyboard commands. The process starts when the central processor detects a request for user interaction with the cube 1; it is received and deciphered according to the operands therein 17. Then the process determines whether or not there is a keyboard or mouse request 18 or other input source such as touch screen, wifi, cell phone etc. If a mouse request has been received the individual action of the mouse is interpreted by an embedded sub-routine or external file call 19. On the other hand, if a keyboard request has been received the individual action of the keyboard is interpreted by an embedded sub-routine or external file call 20. The actions of the aforementioned mouse or keyboard are then transferred by the operating system from RAM into Video RAM 21 or a buffer used for the purpose of loading the images onto the screen. Once loaded the Video Ram data are transferred into real signals 22 that control the pixels on the screen so as to make a rotating image, change link, delete, link etcetera. Then the process repeats in the event another user request has been received (going up to block 17) or continually checks to see if another request has been received in a continuing loop. Of course if power is shutdown housekeeping processes shut this subroutine down as in any other process herein disclosed.

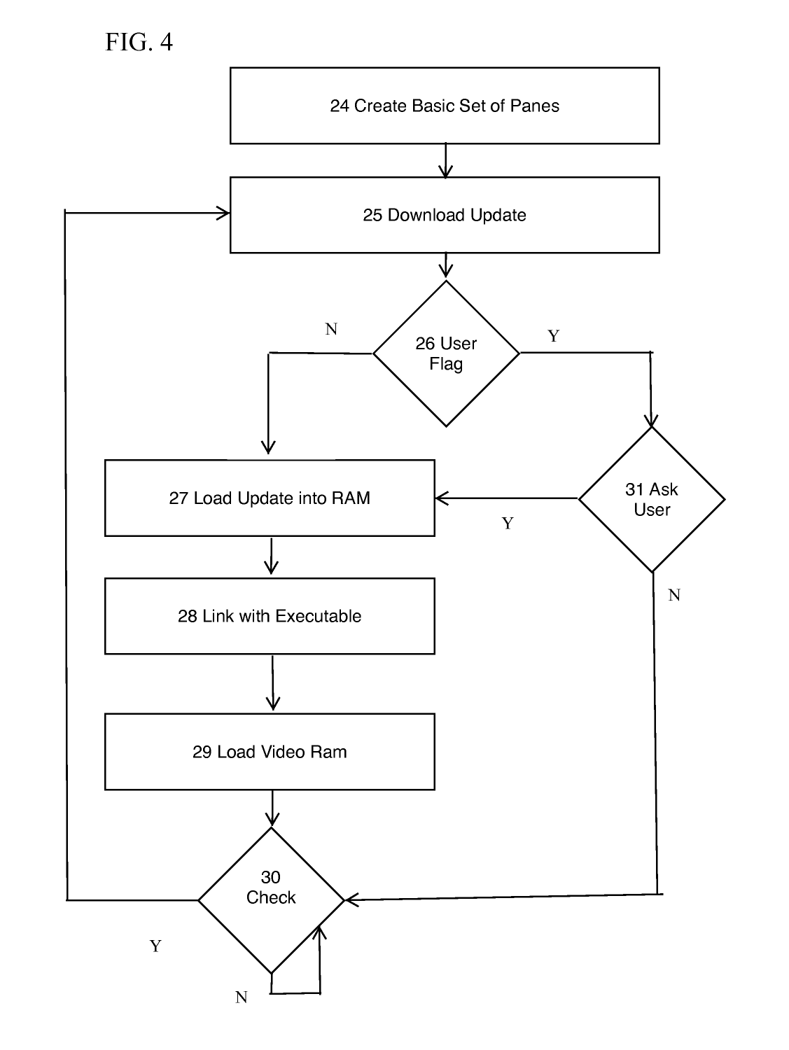

FIG. 4 illustrates how an external file is downloaded via internet so as to update the category headings, basic links, icons and other matter on a continuing basis. This is routinely scheduled and is cancelable based on a user setting a flag in a pop up window or rejecting any further changes. As always, the booting of the operating system created the cube 1 and panes thereof 24 into a rotatable actionable image on the video screen. An update is automatically scheduled to occur at periodic intervals and this update is downloaded 25 into RAM memory; this update includes but is not limited to a statistically generated set of categories for the panes 3, as well as icons and links therein. They can be created by analyzing user surfing data to predict his or her usage patterns and thereby steer the subject matter within the category headings such as NEWS, SOCIAL, POLITICS, MONEY, SEARCH etc. . . . that would most appeal to a user's desires.

Next a determination is made 26 as to whether or not a user flag has been set from a menu pop up that permits a user to customize the categories 5 and content of each pane 3. If a user flag has not been set this means that externally created updates are to be loaded to the categories 5 as well as content of each pane 3. Thus, the update is loaded 27 into regular RAM. It is then linked with an executable file 28 that governs the video control of the image on the screen. At this point the Video RAM is loaded 29 with the changed imagery and a determination is made as to whether or not another update is available 30. If no update is available the process of determination repeats in a loop. If there is an update available the process proceeds back to step 25 to download an update.

However, if a user flag has been set then this means that the user has customized his categories and content. A pop up menu appears on the screen asking the user if he wants to download the update 31 as this will change his customized settings. If he does not want to download the updates then a check is made as to whether an update exists 30 at a next scheduled time frame. If no update is available the process of determination repeats in a loop. If there is an update available the process proceeds back to step 25 to download an update. On the other hand, if a user wants to download an update then the update is loaded 27 into regular RAM. It is then linked with an executable file 28 that governs the video control of the image on the screen. At this point the Video RAM is loaded 29 with the changed imagery and a determination is made as to whether or not another update is available 30. If no update is available the process of determination repeats in a loop. If there is an update available the process proceeds back to step 25 to download an update.

Mobile Phone 3D OS: It should be readily understood that each and every facet of the embodiments presented herein is useable in the computer operating system of a cellular phone, smartphone, PDA, tablet, or other mobile device. Thus, the embodiments are applicable to any of the aforementioned being translatable/programmed into appropriate computer language of the base OS of the particular mobile device, e.g., Android, iOS, Windows etcetera and or translatable/programmed into the underlying real time proprietary OS running the radio and other hardware.

Thus, has been shown how a user can overcome the aforementioned deficiencies by creating a three dimensional interactive browser operating system that permits users to more easily interact with the screen. The system provides headings that are populated via external software download and is overridable by local user control.

Therefore, it is intended that the invention not be limited to the particular embodiments disclosed as the best mode contemplated for carrying out this invention, but that the invention will include all the embodiments falling within the scope of the appended claims.

What is claimed is:

1. A three dimensional browser interface comprising:
a rotatable object having
a pane with
a category theme.

2. The three dimensional browser interface of claim 1, further comprising:
a link within the pane.

3. The three dimensional browser interface of claim 1, further comprising:
an icon within the pane.

4. The three dimensional browser interface of claim 3, further comprising:
an interactive link associated with the icon.

5. The three dimensional browser interface of claim 1, wherein the rotatable object is a polygon.

6. The three dimensional browser interface of claim 1, further comprising:
a plurality of panes connected together wherein each pane is connected to only 2 adjacent panes along edges thereof in a regular polygon structure.

7. A method of creating a graphical user interface GUI comprising the steps of:
creating a 3D model of the GUI
generating a 3D animation layout of the GUI
creating a 3D rendering of the GUI and
combining the rendering of the GUI with a user interface routine.

8. The method of creating a graphical user interface GUI of claim 7, wherein the user interface routine is a mouse interaction routine.

9. The method of creating a graphical user interface GUI of claim 7, wherein the user interface routine is a keyboard interaction routine.

10. The method of creating a graphical user interface GUI of claim 7, wherein the user interface routine is a category interaction routine.

11. The method of creating a graphical user interface GUI of claim 7, wherein the GUI is a 3D regular polygon loaded onto a video screen.

12. A computer program product comprising:
creating a basic set of panes
downloading a category update
checking a user customization flag.

13. The computer program product of claim 12, further comprising:
loading an update if the user customization flag is not set.

14. The computer program product of claim 13, further comprising:
linking the update with an executable file.

15. The computer program product of claim 14, further comprising:
loading the update into video RAM.

16. The computer program product of claim 12, further comprising:
determining if a user wants to load an update if a user customization flag is set.

17. The computer program product of claim 16, further comprising:
checking to see if there is an update available if the user does not want to load the update.

18. The computer program product of claim 16, further comprising:
loading an update if the user permits updating even though a user customization flag is set.

19. The computer program product of claim 18, further comprising:
linking the update with an executable file.

20. The computer program product of claim 19, further comprising:
loading the update into video RAM.
